(19) United States
(12) Patent Application Publication
(10) Pub. No.: US 2026/0220872 A1
(43) Pub. Date: Jul. 30, 2026

(54) METHOD AND SYSTEM FOR GENERATING A 3D TEXTURE IMAGE

(71) Applicant: HUAWEI TECHNOLOGIES CO., LTD., Shenzhen (CN)

(72) Inventors: Yanhui GUO, Kanata (CA); Xinxin ZUO, Kanata (CA); Peng DAI, Kanata (CA); Juwei LU, Kanata (CA); Xiaofei WU, Shenzhen (CN); Songcen XU, Shenzhen (CN); Youliang YAN, Shenzhen (CN)

(21) Appl. No.: 19/574,573

(22) Filed: Mar. 23, 2026

Related U.S. Application Data
(63) Continuation of application No. PCT/CN2023/120213, filed on Sep. 21, 2023.

(51) Int. Cl. G06T 15/04; G06T 5/70

(52) U.S. Cl. CPC G06T 15/04; G06T 5/70

(57) ABSTRACT

The present invention relates to a method for generating a 3D texture image, said method being configured to be executed by at least one computer-implemented system, said method comprising at least optimizing at least one 3D texture; generating at least one global 3D texture image using a resampling model; and optionally, upscaling at least said global 3D texture image to increase the resolution of said global 3D texture image.

### CROSS-REFERENCE

The present application is a continuation of International Patent Application No. PCT/CN2023/120213, with an international filing date of Sep. 21, 2023, and entitled “METHOD AND SYSTEM FOR GENERATING A 3D TEXTURE IMAGE”, the entirety of which is incorporated herein by reference.

### TECHNICAL FIELD

The present technology relates to 3D digital content generation, and more specifically to methods and systems for generating 3D structure-aware texture image.

### BACKGROUND

Recently, 3D digital content has been in high demand for a variety of applications, including Augmented Reality (AR) and Virtual Reality (VR), gaming, entertainment, architecture, and robotics simulation, for example. It is slowly finding its way into virtually every possible domain: retail, online conferencing, virtual social presence, education, etc.

Easier and more user-friendly 3D content generation and editing methods is needed to allow people to freely create their customized 3D models as they expect, as easily as it is to create 2d images using Artificial Intelligence for example.

There are many neural rendering-based methods such as NeRF (see for example: Mildenhall et al. NeRF: Representing Scenes as Neural Radiance Fields for View Synthesis, 2020): A neural radiance field (NeRF) is a fully-connected neural network that can generate novel views of complex 3D scenes, based on a partial set of 2D images. It is trained to use a rendering loss to reproduce input views of a scene. It works by taking input images representing a scene and interpolating between them to render one complete scene. NeRF is a highly effective way to generate images for synthetic data. A NeRF network is trained to map directly from viewing direction and spatial location (5D input) to opacity and color (4D output), using volume rendering to render new views. Said neural rendering-based method can reconstruct 3D content and synthesize novel views. But these methods have limited manipulation capabilities and require prohibitive computation cost for novel view rendering. It has to be noticed that the common NeRF method has critical data requirements: it requires lots of images captured from multi-view directions with known camera parameters to reconstruct a 3D object.

Prior art methods demonstrate the superiority of diffusion model for the image generation task. For example, some solutions try to leverage a pre-trained text-to-image diffusion mode for text-driven object editing while preserving its original characteristics. Other solutions try to address the similar text-driven single-image editing problem diffusion model-based classifier-free guidance. However, these solutions can only solve the editing problem for 2D images.

There is a need for ameliorating these techniques and for developing an innovative technology for 3D content creation.

### SUMMARY

The present technology has been designed to overcome at least some drawbacks present in prior art solutions.

According to an embodiment, the present invention relates to a method and a system to allow convenient 3D-consistent decoration of 3D objects, preferably captured in the wild.

The present invention relates to a method for generating at least one global 3D texture image, said method being configured to be executed by at least one computer-implemented system, said method comprising at least:
Optimizing at least one 3D texture, said step of optimizing being configured to generate a 3D texture ψ based on at least one prompt and on at least one 3D mesh, said step of optimizing comprising at least:
   Generating a 3D texture based on said prompt using at least one pre-trained text-to-image diffusion-based generative model, said pre-trained text-to-image diffusion-based generative model being configured to maintain a coherence between said 3D texture and said 3D mesh; Said step of generating said 3D texture comprising:
      Computing at least one image latent code

$${z}_{t}^{ψ}$$

produced by at least one encoder Vₑ, and
Computing at least one depth latent code

$${z}_{t}^{{ψ}_{d}}$$

downsampled from at least one estimated depth map of said 3D texture;
Concatenating said image latent code

$${z}_{t}^{ψ}$$

and said depth latent code

$${z}_{t}^{{ψ}_{d}}$$

into a concatenation zₜ, and
Forwarding said concatenation zₜ to said pre-trained text-to-image diffusion-based generative model, and
Computing at least one gradient of said 3D texture image as follows:

$${z}_{t} = [ {z}_{t}^{ψ} , {z}_{t}^{{ψ}_{d}} ]$$

$${\tilde{ϵ}}_{ϕ} ( {z}_{t} ; y , t ) = {ϵ}_{ϕ} ( {z}_{t} ; t ) + λ [ {ϵ}_{ϕ} ( {z}_{t} ; y , t ) - {ϵ}_{ϕ} ( {z}_{t} ; t ) ]$$

$${▽}_{ψ} {ℒ}_{sds} ( ϕ , ψ ) = {𝔼}_{t , ϵ} [ w ( t ) ( {ϵ}_{ϕ} ( {z}_{t} ; y , t ) - ϵ ) \frac{\partial {z}_{t}}{\partial {V}_{e}} \frac{\partial {V}_{e}}{\partial ψ} ]$$

where ϵ_{φ} is a denoiser of said pre-trained text-to-image diffusion-based generative model φ, ψ is the 3D texture, λ is the classifier free guidance, y is said prompt embedding from a transformer, w(t) is a weighting function, and ∇_{ψ} [symbol] _{sds}(φ, ψ) is said gradient of said 3D texture image;
   Converting said generated 3D texture from a geometric mapping space into a color image space using at least one neural interpretation model; and
Generating one global 3D texture image using a resampling model, said resampling model having been trained with synthesized view-dependent images using the optimized 3D texture.

Advantageously, the present invention allows synthesizing high-quality textures aligned well with the geometry of a 3D object using preferably a structure-aware 3D texture generation, and advantageously few-view resampling training, and for example super-resolution enhancement.

The present invention has achieved superior performance over state-of-the-art approaches as it will be described.

According to an embodiment, the present invention provides text and image based controllable editing solution for new texture generation which supports 3D consistency in the generated texture. More specifically, and according to a non-limiting example, the present invention uses a 3D triangle mesh as input and a user can provide text prompt, and the invention is configured to generate the textures for the 3D mesh which matches the text prompt of said user.

According to an example, the present invention uses a two-level optimization pipeline to generate at last one 3D texture image, preferably structure-aware, and advantageously with a 4K resolution. Preferably, in the first level, the invention is configured to optimize a UV feature map. Said optimization is advantageously guided with a pre-trained image generation model, preferably a 2D image generation model. According to an embodiment of said invention, First, in each iteration, a texture is rendered into 2D images with sampled camera views, and we also render the 3D geometry into depth maps. The 2D image generation model is conditioned on the rendered depth and the user text prompt. As supervised by at least one pre-trained 2D image generation model, a loss function is computed, and a gradient is configured to flow back to the rendered image views and finally the UV features is updated in 3D. Then, the second level is configured to render said optimized UV features from the first level into several sparse views. Those rendered images are passed into an encoder and decoder network of the pre-trained 2D image generation model. Preferably, another network is trained to aggregate the images from sparse views into a UV texture image. Finally, said UV image is advantageously fed into a pre-trained super-resolution module to get up-sampled into 4K texture.

Preferably, the present invention if configured to use a rendered depth image to maintain a 3D structure-aware generation.

According to an example, the present invention is configured to use at least one rendered depth image as condition to maintain structure-aware information when generating at least one texture. The present allows to get a very high-resolution 3D texture in comparison with the prior art solutions. The present invention allows to generate high quality texture map with 4K resolution.

The present invention is advantageously configured to be deployed in real world for 3D model texture generations applications.

According to an embodiment, the invention is configured to receive a request from a user. Broadly, first, a user can provide some 3D mesh of any object and also a text prompt, the invention is then configured to output 3D consistent and clear textures for the input 3D mesh, and the generated texture matches the text description from the user. The quality of the generated 3D texture is advantageously invariant to the resolution of the input 3D mesh.

The present invention also relates to a computer product program generating at least one 3D texture image which, when executed by at least one computer-implemented system, executes the method according to the present invention.

The present invention also relates to a non-volatile memory comprising at least one computer program product according to the present invention.

The present invention also relates to a computer-implemented system for generating at least one 3D texture image comprising at least:
An optimization module configured to:
   Generate a 3D texture based on a prompt using at least one pre-trained text-to-image diffusion-based generative model, said pre-trained text-to-image diffusion-based generative model being configured to maintain a coherence between said 3D texture and a 3D mesh; and
   Convert said 3D texture from a geometric mapping space into a color image space using at least one neural interpreter; and
A generating module configured to generate one global 3D texture image using a resampling model, said resampling model having been trained with synthesized view-dependent images using a converted 3D texture.

Said computer-implemented system can also comprise an upscaling module configure to upscale said global 3D texture image using at least one super-resolution diffusion model to increase the resolution of said global 3D texture image.

According to an example, the method comprises, after the step of generating said global 3D texture image, a step of upscaling said global 3D texture image using at least one super-resolution diffusion model to increase the resolution of said global 3D texture image.

According to an example, said predicted depth map is estimated from at least one rendered view by using at least one depth estimator of at least one depth-guided diffusion model.

According to an example,

$${z}_{t}^{{ψ}_{d}}$$

is computed by downsampling a rendered depth image to correspond to dimension requirements of said pre-trained text-to-image diffusion-based generative model.

According to an example, said step of generating said 3D texture comprises at least one step of initializing said 3D texture ψ with an output of at least a first multilayer perceptron MLPd, preferably of at least one Multilayer Perceptron with d−1 Hidden Layers MLPd1.

According to an example, said step of converting comprising at least:
Rendering said 3D texture into an image plan; and
Encoding and decoding said rendered 3D texture using at least said pre-trained text-to-image diffusion-based generative model to get at least one 3D texture image;
Said step of converting being formulated as follows:

$${I}_{𝒫} , = V ( ℛ ( ψ , ℳ , 𝒫 ) )$$

where ψ is the optimized 3D texture, V denotes a network of said renderer, and I_{P} is a rendered image given a camera pose P.

According to an example, the training of said resampling model comprises at least:
Representing said optimized 3D texture using at least one multilayer perceptron model; and
Sampling N rendered views using said renderer with the optimized 3D texture ψ;
wherein a few-view resampling training loss is defined as follows:

$${ℒ}_{FVR} ( \tilde{ψ} ) = \frac{1}{N} {\sum }_{i}^{N} {‖ ℛ ( ML {P}_{\tilde{ψ}} ( \tilde{v} ) , ℳ , {𝒫}_{i} ) - V ( ℛ ( ψ , ℳ , {𝒫}_{i} ) ) ‖}^{2}$$

where \tilde{v} denotes a positional encoding of a 2D texture coordinates of the RGB 3D texture, \tilde{ψ} and Pᵢ denotes the i-th sampled camera pose.

According to an example, prompt is taken among a text and/or an image and/or a video and/or a sound.

In the context of the present technology, “Texture” may refer to a digital representation, designed to visually replicate the appearance a real-world surface or material in a virtual environment. A texture can comprise patterns, colors, and surfaces digitally mapped onto a 3-dimensional (3D) virtual object, enhancing the object's aesthetic and realistic attributes.

In the context of the present technology, “consistent texture” may refer to a digital representation or construction of an aesthetic presentation detail that maintains or exhibits coherence, uniformity, stability, or continuity across the surface of a 3D object. This consistency enables the texture to be uniformly applied, manipulated, or mapped onto any part or the entire surface of a 3D object, while retaining its stylistic and visual properties. It comprises aspects of the texture's fundamental characteristics such as color, roughness, smoothness, reflectivity, transparency, and other digital or physical attributes that it may represent, which remain invariant or harmonized in the presence of operations such as rotation, resizing, distortion, lighting changes, or other transformations that the 3D object undergoes. “Consistent texture” may include, but is not limited to, algorithmically derived patterns, synthetic textures, or real-world inspired textures that are digitally captured and processed for applicability on the 3D object in a consistent manner.

In the context of the present invention, “coherence” may refer to the capacity of a texture to maintain an alignment with a 3D mesh, i.e. the maintains coherence with the input 3D mesh. For example, for a 3D human model, the generated facial texture should be attached to the 3D region corresponding to the face.

In the context of the present technology, “3D texture” or “UV texture” may refer to a two-dimensional image assigned on to the surface of a three-dimensional object via UV coordinate system. The term “UV” designates the axes of the 2D image, which can be imagined as a Cartesian plane, whereas, the 3D object or model is typically set within an XYZ Cartesian coordinate system. The UV mapping process involves the point-by-point alignment of each specific point in the 2D texture to corresponding points in the 3D object's surface. The UV texture represents a textured representation on a 3D object surface through computational algorithms which convert the 3D spatial coordinates into the 2D ‘UV’ texture space. This process can enable realistic rendering, simulation, and visualization of 3D models in digital environments, such as in video games, animation, virtual reality, etc.

In the context of the present technology, “structure-aware UV texture” may refer to a UV texture which is sensitive and adaptive to the inherent geometric or structural properties of a 3D object. This implying that the texture mapping approach takes into account the structural characteristics of the 3D model. It may include orientation of surfaces, edges, corners, curvature, among others. This allows for a more realistic and effective texturing that is cognizant of the shape, curvature, edges, and other geometrical features of the 3D object. It provides more accurate behavior of texturing, especially when the texture needs to flow accurately over complex structures, and hence improves overall visual appearance and realism.

In the context of the present technology, “3D digital content” may refer to any material, such as data or information, created and existing in a three-dimensional digital environment. This content can include 3D models, animations, virtual elements, and any other digital objects that have been coded or structured to exist in three spatial dimensions-height, width, and depth. These objects are typically used in different industries such as gaming, film production, architecture, 3D printing, virtual reality, augmented reality, and others. They can be rotated and viewed from different angles, providing a lifelike, immersive experience for users.

In the context of the present technology, “3D mesh” may refer to a type of digital representation applied in the field of 3D computer graphics. It encompasses a collection of vertices, edges, and faces that use polygonal representation, such as triangles or quadrilaterals, to define the shape of a 3-dimensional object. A 3D mesh is usually employed when precise detailing and flexibility are required in the model. For example, a “3D Triangle Mesh” is a specific form of a 3D mesh. It contains a set of triangles that are connected by their edges and vertices to form a 3-dimensional object. Each triangle in a 3D triangle mesh is a flat surface, and combined, they can represent more complex shapes. The primary advantage of using a 3D triangle mesh is its simplicity and computational efficiency, as complex polygons can be simplified into numerous smaller triangles. This feature is widely used in computer graphics and computational modeling.

In the context of the present technology, “geometric mapping space” or “UV space” may refer to a UV atlas map together with a UV texture image. For the UV atlas map, it contains the mapping from 3D mesh to UV texture image. Basically, for each vertice on the 3D mesh, it will map to a UV location (x,y) in the UV texture image.

In the context of the present technology, “color image space” or “RGB space” may refer toa regular RGB image. It has three channels, red/green/blue with range [0, 255].

In the context of the present technology, “depth image” may refer to a kind of graphic representation, where each pixel in the image corresponds not to colors or light intensity, but to a distance or depth from a camera. A depth image portrays an estimation of the distance from a camera or sensor to points in the scene. It is typically represented in a greyscale format, where lighter pixels indicate closer objects and darker pixels represent further ones. Depth images are crucial in fields like robotics, 3D reconstruction, object detection, augmented reality and computer vision for accurate spatial understanding of the environment.

In the context of the present technology, “text prompt” may refer to a string of words, phrase, or sentences that instruct or provide a guideline for an AI model, typically one based on natural language processing, to generate a specific output. The AI model uses this input “text prompt” to understand the context and subsequently produce more text, generate an image or perform a certain task related to the input.

In the context of the present technology, “text-driven generation” may refer to a process within AI and machine learning where algorithms are utilized to generate content, such as sentences, images, videos, or full articles, based on provided text inputs. In other words, this technology synthesizes textual data, learns from its structure, semantics and syntax, and creates new, original content. This kind of technology is regularly used in chatbots, content creation tools, language translation, and various other fields.

In the context of the present technology, “diffusion model” may refer to a type of model in deep learning, a branch of machine learning that mimics the neural circuits of the human brain to process data. The diffusion model is a probabilistic model that deals with the process and pattern of diffusion, that is, the way in which certain information, trends, or behaviors spread throughout a network over time. In the field of AI and computer vision, the diffusion model can be employed in an extensive range of tasks from image generation to restoring damaged images, and other tasks involving complex patterns or predictive analysis. The underlying mechanism of this model involves the training of a neural network to reverse-engineer a diffusion process from a given end result, predicting the original data's properties. One example of such a diffusion model is named “Stable Diffusion” and this model is well-known by the skilled person (see for example the following publication: “Rombach R, Blattmann A, Lorenz D, et al. High-resolution image synthesis with latent diffusion models [C]//Proceedings of the IEEE/CVF conference on computer vision and pattern recognition. 2022:10684-10695”).

In the context of the present technology, “image classification” may refer to categorization and labeling of different groups of images.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first module” and “third module” is not intended to imply any particular order, type, chronology, hierarchy or ranking (for example) of/between the module, nor is their use (by itself) intended imply that any “second module” must necessarily exist in any given situation. Further, as is discussed herein in other contexts, reference to a “first” element and a “second” element does not preclude the two elements from being the same actual real-world element. Thus, for example, in some instances, a “first” module and a “second” module may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates an overview of a step of a method according to an embodiment of the present invention;

FIG. 2 illustrates an example of a method according to an embodiment of the present invention;

FIG. 3 illustrates steps of a method according to an embodiment of the present invention;

FIG. 4 illustrates another steps of a method according to an embodiment of the present invention;

FIG. 5 illustrates an example of a computer-implemented system that may be used to implement any of the methods described herein.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

According to an embodiment, the present invention relates to a method for generating at least one 3D texture image. Said method is configured to be executed by at least one computer-implemented system described hereafter.

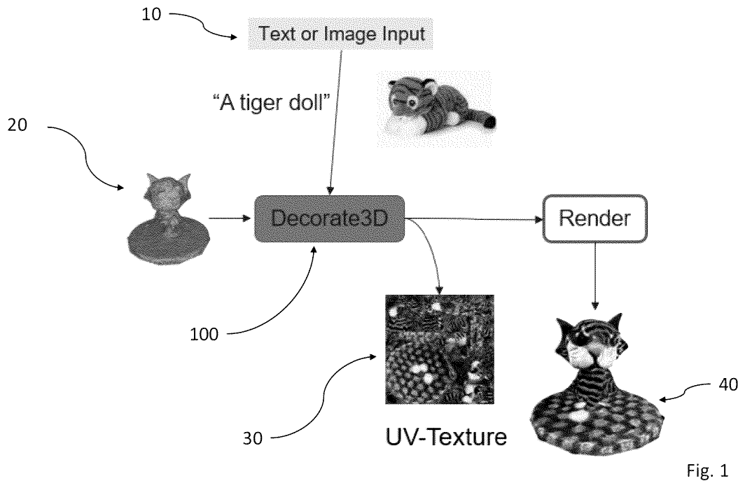

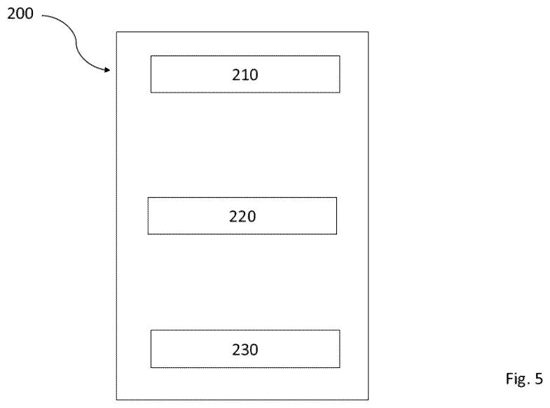

FIG. 1 illustrates an overview of an embodiment of a method. According to said embodiment, a user provides a prompt 10 to a computer-implemented system 200 (as illustrated in FIG. 5) configured to execute said method 100. Said prompt 10 can be a text, such for example “a tiger doll” or an image such for example a picture of a tiger doll. Then, a 3D object, for example a 3D mesh of a doll, is provided to the computer-implemented system 200. Then, the method 100 according to the present invention, is configured to generate a 3D texture 30, i.e. an UV texture, configured to be structure-aware regarding said 3D mesh 20. The present invention allows to generate a textured 3D object 40, said textured 3D object 40 being covered by said 3D texture 30.

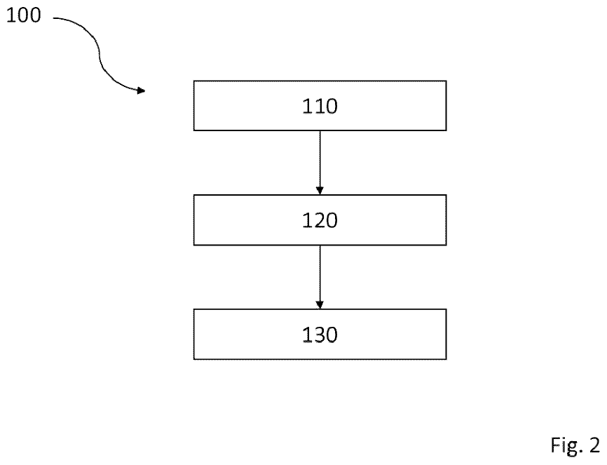

According to an embodiment, and as illustrated by FIG. 2, said method 100 can be called a decoration method as described in details hereafter.

As described hereafter, and according to an embodiment, the method 100 can be divided into three parts, including text-driven UV neural texture optimization, few-view resampling training, and super-resolution on UV texture.

According to an embodiment, the method 100 comprises at least:
Optimizing 110 at least one 3D texture;
Generating 120 at least one global 3D texture image using a resampling model; and
Optionally, upscaling 130 at least said global 3D texture image to increase the resolution of said global 3D texture image.

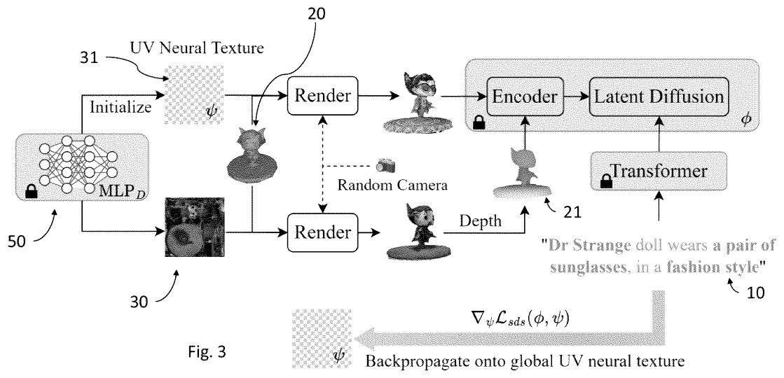

According to an embodiment illustrated by FIG. 3, in the step of optimizing 110, the present invention is configured to optimize a UV feature map (q), i.e. a 3D texture. The optimization is guided preferably with a pre-trained 2D image generation model, such as stable diffusion, for example. First, in each iteration, a current texture is rendered into 2D images with sampled camera views, and a 3D geometry is also rendered into depth maps. The 2D image generation model is conditioned on the rendered depth 21 and the user prompt 10. As supervised by the pre-trained 2D image generation model, a loss function and a gradient are computed and then flow back to the rendered image views and finally the UV features are updated in 3D.

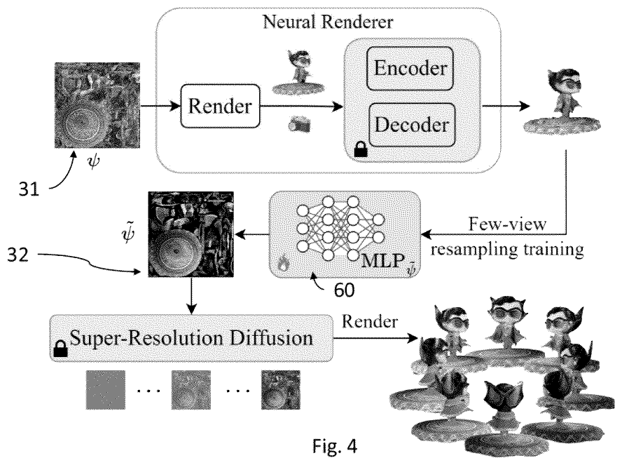

According to an embodiment illustrated by FIG. 4, the optimized UV features from the step of optimizing 110 are rendered into several sparse views. Those rendered images are passed into an encoder and decoder network of the pre-trained 2D image generation model. Then, another network is trained to aggregate the images from sparse views into a UV texture, i.e. a 3D texture. Finally, said UV image is used to feed into a pre-trained super-resolution model get 123 up-sampled into 4K texture, for example.

According to an embodiment, and as described hereafter, said step of optimizing 110 said 3D texture is configured to generate a 3D texture based on at least one prompt; said prompt can for example be provided by a user or a robot or an artificial intelligence. Said prompt can be a text and/or an image and/or a video and/or a sound, for example.

According to an embodiment, and as described in more details hereafter, said step of optimizing 110 comprises at least:
Generating a 3D texture; Said step of generating said 3D texture is configured to use at least said pre-trained text-to-image diffusion-based generative model to maintain a coherence between said 3D texture and said 3D mesh; and
Converting said 3D texture from a geometric mapping space, such as an UV space for example, into at least one color image space, such as a RGB space for example. Said step of converting is configured to use at least one neural interpreter; Said neural interpreter is configured to convert said 3D texture from said geometric space into said color image space.

According to an embodiment, the step of optimizing 110 at least said 3D texture is configured to generate a 3D texture based on a text using a pre-trained text-to-image diffusion-based generative model.

According to an embodiment, the step of generating a 3D texture, preferably a UV neural texture 31 is configured to use a pre-trained text-to-image diffusion-based generative model, such as stable diffusion for example. Said generated 3D texture is preferably based on said prompt 10. Preferably, said pre-trained text-to-image diffusion-based generative model is configured to use said prompt 10 to generate said 3D texture, also called UV neural texture 31. According to an embodiment, said step of generating a 3D texture uses the so-called SDS technique.

According to an example, the SDS technique, well-known by the skilled person in the art (see for example the following publication: “Ben Poole, Ajay Jain, Jonathan T Barron, and Ben Mildenhall. Dreamfusion: Text-to-3d using 2d diffusion. International Conference on Learning Representations (ICLR), 2023.”) for the optimization of the neural texture is used. The SDS technique is designed to achieved text-to-3D generation based on a pre-trained text-to-image diffusion-based generative model (see for example the following publication: “Chitwan Saharia, William Chan, Saurabh Saxena, Lala Li, Jay Whang, Emily Denton, Seyed Kamyar Seyed Ghasemipour, Burcu Karagol Ayan, S. Sara Mahdavi, Rapha Gontijo Lopes, Tim Salimans, Jonathan Ho, David J Fleet, and Mohammad Norouzi. Photorealistic text-to-image diffusion models with deep language understanding, 2022”). This technique can use a NeRF representation to model a scene. Said technique uses preferably a parametric function x=Γ(ξ), which can synthesize an image x at the desired camera pose. Here, Γ is a volumetric renderer, and ξ is a multilayer perceptron (MLP) representing a NeRF scence. The diffusion model φ contains a denoising function ϵ_{φ}(xₜ; y, t) that predicts the sampled noise given the noisy image xₜ at timestep t, and text embedding y. The difference between the noisy image and the denoised image provides the gradient to update ξ such that the density regions with high probability are enforced to match the given text embedding. This gradient update method is named SDS, which is formulated as follows:

$${∇}_{ξ} {ℒ}_{s d s} ( ζ ) = {𝔼}_{t , ϵ} [ w ( t ) ( {ϵ}_{ϕ} ( {x}_{t} ; y , t ) - ϵ ) \frac{\partial {x}_{t}}{\partial ξ} ] \qquad ( Eq . 1 )$$

where the noise ϵ~N (0, I) and w(t) is a weighting function. The neural rendering pipeline Γ(ξ) and the diffusion model φ as modular components of the framework, are amenable to selection. This offers a practical way for text-to-3D synthesis.

According to an embodiment, said step of optimizing 110 said 3D texture is configured to generate a 3D texture for 3D-consistent rendering. Said step is configured to optimize said 3D texture, also called a neural texture, over an UV space. Advantageously, direct texture optimization allows to enforce 3D consistency and to preserve texture details. According to an embodiment, a pre-trained latent diffusion model is used as the optimization guidance, where it has encoder Vₑ, latent diffusion ϵ_{φ}, and decoder V_{d}. According to a non-limiting example, the neural texture ψ∈R^{H×W×3} is set to 3 feature channels to fit the requirement of the diffusion model. The gradient calculated via SDS is backpropagated through the diffusion model's encoder to the UV neural texture at a high resolution of 512×512. Albeit in yielding high-resolution images, the optimization computation is reasonable since the optimization exerts an effect on the latent code

$${z}_{t}^{{ψ}_{=}} {V}_{e} ( R ( ψ , M , P ) )$$

with a resolution of 64×64, where Vₑ is the diffusion model's encoder and P is the sampled camera pose. According to an embodiment, all network parameters are fixed, while only the neural texture ψ is trainable.

Here, the generated texture is called UV Neural Texture by following a deferred neural rendering (see for example the following publication: “Justus Thies, Michael Zollhöfer, and Matthias Nießner. Deferred neural rendering: Image synthesis using neural textures. Acm Transactions on Graphics (TOG), 38 (4):1-12, 2019.”). The generated texture does not act on RGB space, and they are neural features that need a Neural Renderer to interpret.

According to an embodiment, the step of optimizing 110 said 3D texture is configured to maintain a coherence between said 3D texture and said 3D mesh, advantageously using at least one pre-trained text-to-image diffusion-based generative model, such as stable diffusion, for example.

Apart from addressing the 3D-consistency issues, the present invention is configured to also maintain the coherence between 3D geometry and the generated texture. For example, for a 3D human model, the generated facial texture should be attached to the 3D region corresponding to the face. This structure-aware requirement is overlooked by the naive SDS optimization leading to a multi-face Janus problem. To moderate this issue, the present invention utilizes structure-aware SDS optimization by exploiting a depth-guided latent diffusion model (see for example the following publication: “Robin Rombach, Andreas Blattmann, Dominik Lorenz, Patrick Esser, and Björn Ommer. High-resolution image synthesis with latent diffusion models. In Proceedings of the IEEE/CVF Conference on Computer Vision and Pattern Recognition (CVPR), pages 10684-10695, June 2022”).

In detail, at each denoising step t, the present invention is configured to advantageously compute the image latent code

$${z}_{t}^{ψ}$$

produced by the encoder Vₑ and the depth latent code

$${z}_{t}^{{ψ}_{d}}$$

downsampled from the estimated depth map. They are concatenated as zₜ and forwarded to the latent diffusion module (Eq. 3). Then, following the SDS technique, the gradient of neural texture is computed (Eq. 4).

According to an embodiment, said step of optimizing said 3D texture comprises at least:
Computing at least one image latent code

$${z}_{t}^{ψ}$$

produced by at least one encoder Vₑ, and
Computing at least one depth latent code

$${z}_{t}^{{ψ}_{d}}$$

downsampled from at least one estimated depth map of said 3D texture; said predicted depth map can be estimated from at least one rendered view by using at least one depth estimator of at least one depth-guided diffusion model, for example;
Concatenating said image lent code and said depth latent code into a concatenation zₜ, and
Forwarding said concatenation zₜ to at least at least said pre-trained text-to-image diffusion-based generative model, and
Computing at least one gradient of said 3D texture as follows:

$${z}_{t} = [ {z}_{t}^{ψ} , {z}_{t}^{{ψ}_{d}} ] \qquad ( Eq . 2 )$$

$${\tilde{ϵ}}_{ϕ} ( {z}_{t} ; y , t ) = {ϵ}_{ϕ} ( {z}_{t} ; t ) + λ [ {ϵ}_{ϕ} ( {z}_{t} ; y , t ) - {ϵ}_{ϕ} ( {z}_{t} ; t ) ] \qquad ( Eq . 3 )$$

$${∇}_{ψ} {ℒ}_{sds} ( ϕ , ψ ) = {𝔼}_{t , ∈} [ w ( t ) ( {ϵ}_{ϕ} ( {z}_{t} ; y , t ) - ϵ ) \frac{\partial {z}_{t} \partial {V}_{e}}{\partial {V}_{e} \partial ψ} ] \qquad ( Eq . 4 )$$

where ϵ_{φ} is a diffusion model's denoiser, y is a text embedding from the Transformer, and w(t) is a weighting function.

According to an embodiment, at each denoising step t, the current UV texture is rendered into sampled view direction, and the rendered image is then forwarded into the encoder Vₑ of stable-diffusion model, and to get said

$${z}_{t}^{ψ}$$

which is a latent code of current render.

Preferably,

$${z}_{t}^{{ψ}_{d}}$$

is the corresponding depth latent code which is achieved by downsampling the rendered depth image 21 to meet the dimension requirements of pre-trained depth-conditioned stable diffusion model. Advantageously, zₜ is the concatenation of

$${z}_{t}^{ψ}$$

and

$${z}_{t}^{{ψ}_{d}} ;$$

ϵ_{φ} is the denoiser of pre-trained depth-conditioned stable diffusion model; λ is the classifier free guidance (CFG) scale which is set to be 100, for example; ε is a sampled noise map from a standard normal distribution; and ψ is the UV texture to be optimized.

Preferably, the present invention uses the classifier-free guidance scheme (See for example the following publication: “Alexander Quinn Nichol, Prafulla Dhariwal, Aditya Ramesh, Pranav Shyam, Pamela Mishkin, Bob Mcgrew, Ilya Sutskever, and Mark Chen. Glide: Towards photorealistic image generation and editing with text-guided diffusion models. In International Conference on Machine Learning, pages 16784-16804. PMLR, 2022.”) as stated in Eq. 3, and the guidance weight λ for text conditioning is set to a predetermined number, equal to 100 for example. To match the depth-guided diffusion model, depth maps are predicted from the rendered views by using at least one depth estimator (see for example the following publication: “René Ranftl, Katrin Lasinger, David Hafner, Konrad Schindler, and Vladlen Koltun. Towards robust monocular depth estimation: Mixing datasets for zero-shot cross-dataset transfer. IEEE transactions on pattern analysis and machine intelligence, 44 (3): 1623-1637, 2020.”) of the depth-guided diffusion model rather than using the depth buffer of the rendering pipeline. The overall SDS optimization framework is shown in the left bottom of FIG. 4.

According to an embodiment, said step of optimizing 110 said 3D texture comprises at least one step of initializing of said 3D texture ψ 31 with an output of at least a first multilayer perceptron MLPd 50, preferably of at least one Multilayer Perceptron with d−1 Hidden Layers MLPd.

Indeed, according to an embodiment, in addition to structure-aware SDS optimization, the present invention can comprise a structure-aware initialization. The present invention can have an inherent texture that well matches the geometry information extracted from the real-world object, for example. Therefore, the present invention can initialize the neural texture ψ 31 with the output of at least a first multilayer perceptron MLPd 50. This initialization can accelerate the convergence speed as well as provide structure-aware information to help it converge to a structure-aware solution.

According to an embodiment, the step of converting is configured to convert said optimized 3D texture from a geometric mapping space, preferably an UV space, into at least one color image space, preferably a RGB space, using at least one neural interpreter.

As aforementioned, directly optimizing the UV texture with SDS does not yield a traditional RGB UV texture for the rendering pipeline. The optimized texture i.e. neural texture requires a neural interpreter to convert it back to RGB space after the SDS optimization. Previous work (see for example the following publication: “Gal Metzer, Elad Richardson, Or Patashnik, Raja Giryes, and Daniel Cohen-Or. Latent-nerf for shape-guided generation of 3d shapes and textures. IEEE Conference on Computer Vision and Pattern Recognition (CVPR), 2023.”) applied a statistical linear transformation matrix on the optimized UV texture to interpret in the RGB UV space. But this transformation matrix is suboptimal and the misalignment will result in color shifts and blur artifacts.

According to an embodiment, said step of converting comprising at least:
Rendering said 3D texture into an image plan; and
Encoding and decoding said rendered 3D texture using at least said pre-trained text-to-image diffusion-based generative model to get at least one texture image.

According to an embodiment, a neural renderer is used as the interpreter to synthesize photo-realistic images from the optimized neural texture. This rendering process, i.e. said step of converting, can be formulated as follows:

$${I}_{𝒫} = V ( ℛ ( ψ , ℳ , 𝒫 ) ) \qquad ( Eq . 5 )$$

where ψ is the neural texture, V denotes the network of the neural renderer, and I_{P} is the rendered image given the camera pose P. Here, the neural renderer network V is the encoder-decoder (i.e. VAE) module of the depth-guided latent diffusion model. The network V and the traditional renderer R have amalgamated to form the neural renderer.

According to an embodiment, the step of training said resampling model is configured to generate at least one global 3D texture from synthesized view-dependent images of said optimized 3D texture.

With the neural texture, the present invention can render 3D-consistent high-quality views I_{P} through the Neural Renderer (with Eq. 5) by sampling different camera poses.

The present invention can avoid some jittering problems. According to an embodiment, the present invention is configured to execute a few-view resampling (FVR) training process, that transfers the synthesized view-dependent images into a global UV texture \tilde{ψ}. As shown in FIG. 4, a second multilayer perceptron MLP \tilde{ψ} 60 can be used to represent the UV texture \tilde{ψ} 32. In the FVR training, N rendered views are sampled using the neural renderer with the neural texture ψ 31. Preferably, the sampled N views are designed to overlay the mesh surface as much as possible. But setting a big N, for example larger than 64 views, may bring negative effects, leading to over-smoothing textures on the overlapped areas that suffer jittering artifacts.

According to an embodiment, the step of generating 120 said global 3D texture image using a resampling model comprises at least:
Representing said converted 3D texture using at least one multilayer perceptron model; and
Sampling N rendered views using said neural renderer with the optimized 3D texture ψ.

According to an embodiment, said resampling model has been trained with synthesized view-dependent images using said optimized 3D texture.

According to an embodiment, said FVR training loss can be defined as follows:

$${ℒ}_{FVR} ( \tilde{ψ} ) = \frac{1}{N} {\sum }_{i}^{N} {‖ ℛ ( {MLP}_{\tilde{ψ}} ( \tilde{v} ) , ℳ , {𝒫}_{i} ) - V ( ℛ ( ψ , ℳ , {𝒫}_{i} ) ) ‖}^{2} \qquad ( Eq . 11 )$$

where \tilde{v} denotes the positional encoding of the 2D UV coordinates of the RGB UV texture \tilde{ψ}, and Pi denotes the i-th sampled camera pose. The pose is sampled in spherical coordinates, with two elevation angles θ_{cam} chosen from {−20°, +200}, four azimuth angles β_{cam} uniformly sampled between [0°, 360°], and an appropriate viewing distance r_{cam}. According to an example, N can be set to be equal to 8.

According to an embodiment, the step of upscaling 130 said global 3D texture is configured to increase the resolution of said global 3D texture.

From the SDS approaches, it is only possible to synthesize images at the resolution of 512 times 512. To further improve the spatial resolution of the UV texture \tilde{ψ}, the present invention advantageously applies a super-resolution (SR) diffusion model with a ×4 scale factor (see for example the following publication: “Chitwan Saharia, Jonathan Ho, William Chan, Tim Salimans, David J Fleet, and Mohammad Norouzi. Image super-resolution via iterative refinement. IEEE Transactions on Pattern Analysis and Machine Intelligence, 2022.”) on the UV texture to obtain a 2048×2048 UV texture. The rationale behind this successful application of UV texture upscaling is that the upsampling operation has a spatial locality, concentrating on local textures such as edges. For this reason, SR models are usually trained by cropped image patches (see for example the following publication: “Wenzhe Shi, Jose Caballero, Ferenc Huszár, Johannes Totz, Andrew P Aitken, Rob Bishop, Daniel Rueckert, and Zehan Wang. Real-time single image and video super-resolution using an efficient sub-pixel convolutional neural network. In Proceedings of the IEEE conference on computer vision and pattern recognition, pages 1874-1883, 2016.”) instead of the whole image to increase the training efficiency. This spatial locality of SR allows the SR model trained on natural images to be directly applied to the UV texture. Directly applying the SR operation to the UV texture is free from any jittering issues and 3D consistency is well preserved.

According to an embodiment, as illustrated in FIG. 5, the present invention relates to a computer-implemented system 200 for generating at least one 3D texture image. Said computer-implemented system is configured to execute the method according to the present invention.

According to an embodiment, said computer-implemented system 200 comprises a module 210 configured to execute said decoration phase.

According to an embodiment, said module 210 is configured to optimize the view dependent texture, and preferably to generate a 3D texture, advantageously based on at least one prompt.

According to an embodiment, said computer-implemented system 200 comprises:
An optimization module 210 configured to:
   Generate a 3D texture based on a prompt using at least one pre-trained text-to-image diffusion-based generative model, said pre-trained text-to-image diffusion-based generative model being configured to maintain a coherence between said 3D texture and a 3D mesh; and
   Convert said 3D texture from a geometric mapping space into a color image space using at least one neural interpreter;
A generating module 220 configured to generate one global 3D texture image using a resampling model, said resampling model having been trained with synthesized view-dependent images using a converted 3D texture; and
An upscaling module 230 configure to upscale said global 3D texture image using at least one super-resolution diffusion model to increase the resolution of said global 3D texture image.

According to an embodiment, said optimization module 210 configured to:
Compute at least one image latent code

$${z}_{t}^{ψ}$$

produced by at least one encoder Vₑ, and
Compute at least one depth latent code downsampled from at least one

$${z}_{t}^{{ψ}_{d}}$$

downsampled from at least one estimated depth map of said 3D texture; said predicted depth map can be estimated from at least one rendered view by using at least one depth estimator of at least one depth-guided diffusion model, for example;
Concatenate said image lent code and said depth latent code into a concatenation zₜ, and
Forward said concatenation zₜ to at least said pre-trained text-to-image diffusion-based generative model, and
Compute at least one gradient of said 3D texture;

According to an embodiment, said optimization module 210 is also configured to:
Render said 3D texture into an image plan; and
Encode and decode said rendered 3D texture using at least said pre-trained text-to-image diffusion-based generative model to get at least one texture image.

According to an embodiment, said generating module 220 is configured to generate at least one global 3D texture image, preferably using a resampling model. Advantageously, the generating module 220 is configured to train at least one resampling model with synthesized view-dependent images using the optimized 3D texture image. Preferably, said second module is configured to:
Represent said converted 3D texture using at least one multilayer perceptron model; and
Sample N rendered views using said neural renderer with the optimized 3D texture ψ.

According to an embodiment, said computer-implemented system 200 is configured to execute at least a plurality of instructions, preferably stored in a non-volatile storage device; these instructions are configured to execute the method 100 according to the present invention when they are executed by at least one processor of said computer-implemented system 200.

According to an embodiment, said computer-implemented system 200 can comprise a computer or any electronic device similar to a computer. Optionally, said computer-implemented system 200 can be coupled with a communication network, for example by way of two-way communication lines. Said computer-implemented system 200 can comprise a user interface, for example a keyboard, a mouse, voice recognition capabilities or other interface permitting the user to access and provide input to computer-implemented system. Said computer-implemented system 200 can comprise at least one monitor. Said computer-implemented system 200 can comprise a CPU. Said computer-implemented system 200 can be a desktop computer or a laptop computer, for example, or even a web server. According to an embodiment, said computer-implemented system can comprise at least one optical device. Said optical device can be configured to capture, i.e. to acquire, at least one image, preferably a plurality of images. Said image can be a prompt. Said plurality of images can be used to generate a 3D object and a view-dependent texture.

Unless otherwise specified herein, or unless the context clearly dictates otherwise the term about modifying a numerical quantity means plus or minus ten percent. Unless otherwise specified, or unless the context dictates otherwise, between two numerical values is to be read as between and including the two numerical values.

In the present description, some specific details are included to provide an understanding of various disclosed implementations. The skilled person in the relevant art, however, will recognize that implementations may be practiced without one or more of these specific details, parts of a method, components, materials, etc. In some instances, well-known methods associated with artificial intelligence, machine learning and/or neural networks, have not been shown or described in detail to avoid unnecessarily obscuring descriptions of the disclosed implementations.

In the present description and appended claims “a”, “an”, “one”, or “another” applied to “embodiment”, “example”, or “implementation” is used in the sense that a particular referent feature, structure, or characteristic described in connection with the embodiment, example, or implementation is included in at least one embodiment, example, or implementation. Thus, phrases like “in one embodiment”, “in an embodiment”, or “another embodiment” are not necessarily all referring to the same embodiment. Furthermore, the particular features, structures, or characteristics may be combined in any suitable manner in one or more embodiments, examples, or implementations.

As used in this description and the appended claims, the singular forms of articles, such as “a”, “an”, and “the”, can include plural referents unless the context mandates otherwise. Unless the context requires otherwise, throughout this description and appended claims, the word “comprise” and variations thereof, such as, “comprises” and “comprising” are to be interpreted in an open, inclusive sense, that is, as “including, but not limited to”.

All scientific publications referred to in this description, are incorporated by reference in their entireties for all purposes herein.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

### REFERENCES

10 Prompt
20 3D mesh
21 Depth image
30 3D texture image
31 UV neural texture
32 RGB UV texture
40 3D object with 3D texture image
50 First multilayer perceptron
60 Second multilayer perceptron
100 Method for generating a 3D texture image
110 Optimizing view dependent texture
120 Generating one global 3D texture image
130 Upscaling 3D Texture
200 Computer-implemented system
210 Optimization module
220 Generating module
230 Upscaling module

1. A method for generating at least one global 3D texture image, said method being configured to be executed by at least one computer-implemented system, said method comprising at least:
optimizing at least one 3D texture, said step of optimizing being configured to generate a 3D texture ψ based on at least one prompt and on at least one 3D mesh, said step of optimizing comprising at least:
generating a 3D texture based on said prompt using at least one pre-trained text-to-image diffusion-based generative model, said pre-trained text-to-image diffusion-based generative model being configured to maintain a coherence between said 3D texture and said 3D mesh; Said step of generating said 3D texture comprising:
computing at least one image latent code
$${z}_{t}^{ψ}$$
produced by at least one encoder Vₑ, and
computing at least one depth latent code
$${z}_{t}^{{ψ}_{d}}$$
downsampled from at least one estimated depth map of said 3D texture;
concatenating said image latent code
$${z}_{t}^{ψ}$$
and said depth latent code
$${z}_{t}^{{ψ}_{d}}$$
into a concatenation zₜ, and
forwarding said concatenation zₜ to said pre-trained text-to-image diffusion-based generative model, and
computing at least one gradient of said 3D texture image as follows:
$${z}_{t} = [ {z}_{t}^{ψ} , {z}_{t}^{{ψ}_{d}} ]$$
$${\tilde{ϵ}}_{ϕ} ( {z}_{t} ; y , t ) = {ϵ}_{ϕ} ( {z}_{t} ; t ) + λ [ {ϵ}_{ϕ} ( {z}_{t} ; y , t ) - {ϵ}_{ϕ} ( {z}_{t} ; t ) ]$$
$${∇}_{ψ} {ℒ}_{sds} ( ϕ , ψ ) = {𝔼}_{t , ϵ} [ w ( t ) ( {ϵ}_{ϕ} ( {z}_{t} ; y , t ) - ϵ ) \frac{\partial {z}_{t}}{\partial {V}_{e}} \frac{\partial {V}_{e}}{\partial ψ} ]$$
where ϵ_{φ} is a denoiser of said pre-trained text-to-image diffusion-based generative model φ, ψ is the 3D texture, λ is a classifier free guidance, y is said prompt embedding from a transformer, w(t) is a weighting function, and ∇_{ψ} [symbol] _{sds}(φ, ψ) is said gradient of said 3D texture image;
converting said generated 3D texture from a geometric mapping space into a color image space using at least one neural interpretation model;
generating one global 3D texture image using a resampling model, said resampling model having been trained with synthesized view-dependent images using the optimized 3D texture.

2. The method according to claim 1 comprising, after the step of generating said global 3D texture image, a step of upscaling said global 3D texture image using at least one super-resolution diffusion model to increase a resolution of said global 3D texture image.

3. The method according to claim 1 wherein, said estimated depth map is estimated from at least one rendered view by using at least one depth estimator of at least one depth-guided diffusion model.

4. The method according claim 1, wherein
$${z}_{t}^{{ψ}_{d}}$$
is computed by downsampling a rendered depth image to correspond to dimension requirements of said pre-trained text-to-image diffusion-based generative model.

5. The method according to claim 1, wherein said step of generating said 3D texture comprises at least one step of initializing said 3D texture with an output of at least a first multilayer perceptron MLPd, preferably of at least one Multilayer Perceptron with d−1 Hidden Layers MLPd1.

6. The method according to claim 1, wherein said step of converting comprising at least:
rendering said 3D texture into an image plan;
encoding and decoding said rendered 3D texture using at least said pre-trained text-to-image diffusion-based generative model to get at least one 3D texture image; and
said step of converting being formulated as follows:
$${I}_{𝒫} = V ( ℛ ( ψ , ℳ , 𝒫 ) )$$
where ψ is the optimized 3D texture, V denotes a network of said renderer, and I_{P} is a rendered image given a camera pose P.

7. The method according to claim 1, wherein the training of said resampling model comprises at least:
representing said optimized 3D texture using at least one multilayer perceptron model;
sampling N rendered views using said renderer with the optimized 3D texture; and
wherein a few-view resampling training loss is defined as follows:
$${ℒ}_{FVR} ( \tilde{ψ} ) = \frac{1}{N} {\sum }_{i}^{N} {‖ ℛ ( {MLP}_{\tilde{ψ}} ( \tilde{v} ) , ℳ , {𝒫}_{i} ) - V ( ℛ ( ψ , ℳ , {𝒫}_{i} ) ) ‖}^{2}$$
where \tilde{v} denotes a positional encoding of a 2D texture coordinates of a RGB 3D texture \tilde{ψ}, and Pᵢ denotes an i-th sampled camera pose.

8. The method according to claim 1, wherein said prompt is taken among a text and/or an image and/or a video and/or a sound.

9. A computer product program generating at least one 3D texture image which, when executed by at least one computer-implemented system, executes the method according to claim 1.

10. A computer-implemented system for generating at least one 3D texture image comprising at least:
an optimization module configured to:
generate a 3D texture based on a prompt using at least one pre-trained text-to-image diffusion-based generative model, said pre-trained text-to-image diffusion-based generative model being configured to maintain a coherence between said 3D texture and a 3D mesh;
convert said 3D texture from a geometric mapping space into a color image space using at least one neural interpreter; and
a generating module configured to generate one global 3D texture image using a resampling model, said resampling model having been trained with synthesized view-dependent images using a converted 3D texture.

11. The computer-implemented system according to claim 10, comprising an upscaling module configured to upscale said global 3D texture image using at least one super-resolution diffusion model to increase a resolution of said global 3D texture image.
